(19) United States
(12) Patent Application Publication
(10) Pub. No.: US 2015/0193355 A1
(43) Pub. Date: Jul. 9, 2015

(54) PARTITIONED CACHE REPLACEMENT ALGORITHM

(71) Applicant: Samsung Electronics Co., Ltd., Suwon-si (KR)

(72) Inventors: William HUGHES, San Jose, CA (US); Kevin LEPAK, Austin, TX (US)

(73) Assignee: Samsung Electronics Co., Ltd., Suwon-si (KR)

(21) Appl. No.: 14/591,322

(22) Filed: Jan. 7, 2015

Related U.S. Application Data
(60) Provisional application No. 61/924,378, filed on Jan. 7, 2014.

(51) Int. Cl. G06F 12/12; G06F 12/08

(52) U.S. Cl. CPC G06F 12/122; G06F 12/0848; G06F 2212/69; G06F 2212/282

(57) ABSTRACT

Cache replacement policy mechanism for updating cache entries of a partitioned cache using a pseudo-LRU (least recently updated) scheme for partial updating of LRU bits.

### CROSS-REFERENCE TO RELATED PATENT APPLICATION

This application claims the benefit of U.S. Provisional Application No. 61,924,378, filed on Jan. 7, 2014, in the United States Patent and Trademark Office, the disclosure of which is incorporated herein by reference in its entirety.

### BACKGROUND

1. Field

Methods and apparatuses consistent with embodiments relate to integrated circuit cache designs, and more particularly to a method and apparatus by which lines in a cache are chosen for replacement when a new entry is written into a partitioned cache.

2. Description of Related Art

Caches are typically constructed with associativity, in which some number of cache entries (i.e., ways) are present for each cache index address. When a new line is allocated into the cache, and all the ways at the index corresponding to the new line are valid, then one of the valid ways must be selected for replacement.

Traditional caches use many different methods for optimizing the choice of the replacement way (e.g., cache replacement policy) based on how often or how recently each way has been accessed. Using an indication of how recently a line has been accessed allows lines, which have not been recently accessed, to be selected for replacement. Thereby, lines in the cache, which have been recently accessed, are preserved and are more likely to be accessed again.

Traditional cache replacement policies, however, do not provide for or support cache partitioning.

Cache partitioning allows cache resources to be shared among a number of requestors, such as a central processing unit (CPU), a graphics processing unit (GPU), a network interface, etc. that request access to the cache. For example, a CPU may be allocated access to all ways of the cache. On the other hand, the GPU may be restricted to access only one partition of the cache, to avoid polluting the cache, and the network interface may be restricted to access only a portion or sub-portion of the cache, which may be separate from the portion of the cache allocated to the GPU.

Accordingly, a cache replacement mechanism that supports a flexible partitioning scheme without increasing area or complexity is desirable.

### SUMMARY

Embodiments may overcome the above disadvantages. However, an embodiment is not required to overcome the above disadvantages.

According to an aspect of an exemplary embodiment, there is provided a method of performing cache replacement in a cache partitioned into a plurality of partitions, the method including receiving a request from a requestor to allocate a cache entry into a partition among the plurality of partitions, determining a least recently used (LRU) cache entry among cache entries in the partition, allocating the cache entry in the partition, and setting a next LRU cache entry within the partition.

According to an aspect of an exemplary embodiment, there is provided a memory controller configured to perform cache replacement in a cache partitioned into a plurality of partitions, the memory controller including a processing module configured to receive a request from a requestor to allocate a cache entry into a partition among the plurality of partitions, determine a least recently used (LRU) cache entry among cache entries in the partition, allocate the cache entry in the partition, and set a next LRU cache entry within the partition.

### BRIEF DESCRIPTION OF THE DRAWINGS

The above and/or other aspects will become more apparent by describing in detail embodiments with reference to the attached drawings in which:

FIG. 1 illustrates a 16-way cache.

FIGS. 2A and 2B illustrate a pseudo-LRU replacement mechanism.

FIG. 3 illustrates a partitioned cache applying a pseudo-LRU replacement policy, according to an embodiment.

FIG. 4 illustrates a partitioned cache for pseudo-LRU replacement mechanism, according to an embodiment.

FIG. 5 illustrates a partitioned cache for pseudo-LRU replacement mechanism, according to an embodiment.

FIG. 6 illustrates a method of managing a partitioned cache according to a pseudo-LRU replacement policy.

### DETAILED DESCRIPTION OF EMBODIMENTS

Embodiments will now be described more fully with reference to the accompanying drawings, in which like reference numerals refer to like elements throughout.

Expressions such as “at least one of,” when preceding a list of elements, modify the entire list of elements and do not modify the individual elements of the list.

The matters defined in the description, such as detailed construction and elements, are provided to assist in a comprehensive understanding of the embodiments. However, it is understood that the embodiments may be practiced without those specifically defined matters. Also, well-known functions or constructions are not described in detail because they would obscure the description with unnecessary detail.

Various embodiments will be described more fully hereinafter with reference to the accompanying drawings, in which various aspects of embodiments are shown. The embodiments may, however, be embodied in many different forms and should not be construed as limited to embodiments set forth herein. Rather, these embodiments are provided so that this disclosure will be thorough and complete, and will fully convey the scope of various aspects of embodiments to those skilled in the art. In the drawings, the sizes and relative sizes of layers and regions may be exaggerated for clarity.

In the following description, terms such as “unit,” “module,” and “block” indicate a unit for processing at least one function or operation, wherein the unit, module, and block may be embodied as hardware circuitry or software or may be embodied by combining hardware circuitry and software.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of embodiments.

The terminology used herein is for the purpose of describing various aspects of particular embodiments only and is not intended to be limiting of embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which the embodiments relate. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

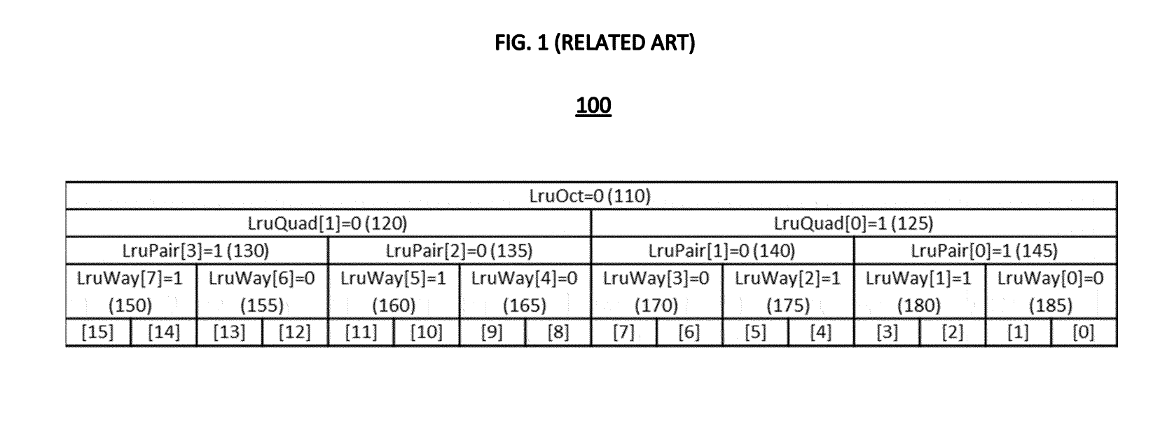

FIG. 1 illustrates a 16-way cache.

In some cache applications, it may be advantageous to partition a cache among two or more different requestors. By limiting access to various partitions of the cache among the different requestors, the degree to which one requestor may dominate the cache with new allocations, and hence replace many of the cache lines required by a different requestor, may be limited. Accordingly, more efficient cache replacement may be attained.

Examples of requestors include a central processing unit (CPU), a graphics processing unit (GPU), display controllers, video encoders and video decoders, and networking interfaces. Because each requestor may have different latency, bandwidth, and temporal locality characteristics, cache replacement may be optimized by partitioning a cache among different requestors or groups of requestors.

According to embodiments discussed below, partitioning a cache allows the cache's associativity to be split into different partitions such that some subset of ways may be allocated to each requestor or requestor group.

A 16-way cache is used throughout this disclosure as an example, and is illustrated in FIG. 1.

The 16-way cache (100) forms a tree-based hierarchy: the LruOct bit (110), LruQuad[1:0] bits (120, 125), LruPair[3:0] bits (130, 135, 140, 145), and LruWay[7:0] bits (150, 155, 160, 165, 170, 175, 180, 185) form a three-level tree-based least recently used (LRU) select hierarchy to indicate which entry 0 to 15 is least recently used and eligible for replacement. The cache (100) may be a last level of cache in a system, for example a level two (L2) cache, that is accessed by multiple requestors, such as multiple CPUs, multiple CPU cores, CPU clusters operating on a system-on-chip (SoC), or groups of CPUs or CPU cores.

To determine which way [15:0] (i.e., cache entry) to replace, the bits (110-185) in the cache (100) may be examined.

The LruOct bit (110) indicates whether the replacement way is in the upper or lower 8 ways (oct). The corresponding LruQuad bit (120, 125) for the 8 ways indicated by the LruOct bit (110) indicates whether the replacement way is in the upper or lower 4 ways (quad). The corresponding LruPair bit (130-145) for the 4 ways indicated by the LruQuad bit (120, 125) indicates whether the replacement way is in the upper or lower 2 ways (pair). Last, the corresponding LruWay (150-185) bit for the 2 ways indicated by the LruPair bit (130-145) indicates whether the replacement way is the upper or lower way.

A simple cache replacement policy is random replacement, in which no storage bits are required, but no attempt is made to optimize the choice of the replacement way.

At the opposite end of the spectrum, a list approach may be used, in which a list of pointers to all 16 ways is maintained, with the least recently used way pointed to at one end of the list and the most recently used way pointed to at the other end of the list. Each cache access manipulates the list to remove the entry accessed from the ordered list (or add a new entry) and placing the accessed entry at the position of the most recently used entry in the list. When a new cache allocation is required, the least recently used entry is selected for replacement. Accordingly, this method is accurate, but requires many bits (e.g., 16 cache entries×4 bits=64 bits).

A pseudo-LRU algorithm may approximately track the least recently used way, while using fewer bits that the full list mechanism (e.g., 15 bits for 16-ways), and hence the pseudo-LRU mechanism is much more area efficient. Such structure, therefore, is more suitable for a partitioned cache, as discussed in greater detail below.

Table 1 below illustrates a pseudo-LRU replacement mechanism:

TABLE 1

| Group | Name | Description |
|---|---|---|
| Way | LruWay[0] | Indicates whether way[1] (1) or way[0] (0) |
| selects | | is the LRU. |
| | LruWay[1] | Indicates whether way[3] (1) or way[2] (0) |
| | | is the LRU. |
| | LruWay[2] | Indicates whether way[5] (1) or way[4] (0) |
| | | is the LRU. |
| | LruWay[3] | Indicates whether way[7] (1) or way[6] (0) |
| | | is the LRU. |
| | LruWay[4] | Indicates whether way[9] (1) or way[8] (0) |
| | | is the LRU. |
| | LruWay[5] | Indicates whether way[11] (1) or way[10] (0) |
| | | is the LRU. |
| | LruWay[6] | Indicates whether way[13] (1) or way[12] (0) |
| | | is the LRU. |
| | LruWay[7] | Indicates whether way[15] (1) or way[14] (0) |
| | | is the LRU. |
| Pair | LruPair[0] | Indicates whether the way[3:2] (1) or way |
| selects | | [1:0] (0) pair is the LRU |
| | LruPair[1] | Indicates whether the way[7:6] (1) or way |
| | | [5:4] (0) pair is the LRU |
| | LruPair[2] | Indicates whether the way[11:10] (1) or way |
| | | [9:8] (0) pair is the LRU |
| | LruPair[3] | Indicates whether the way[15:14] (1) or way |
| | | [13:12] (0) pair is the LRU |
| Quad | LruQuad[0] | Indicates whether the way[7:4] (1) or way |
| selects | | [3:0] (0) quad is the LRU |
| | LruQuad[1] | Indicates whether the way[15:12] (1) or way |
| | | [11:8] (0) quad is the LRU |
| Oct | LruOct | Indicates whether the way[15:8] (1) or way |
| select | | [7:0] (0) oct is the LRU |

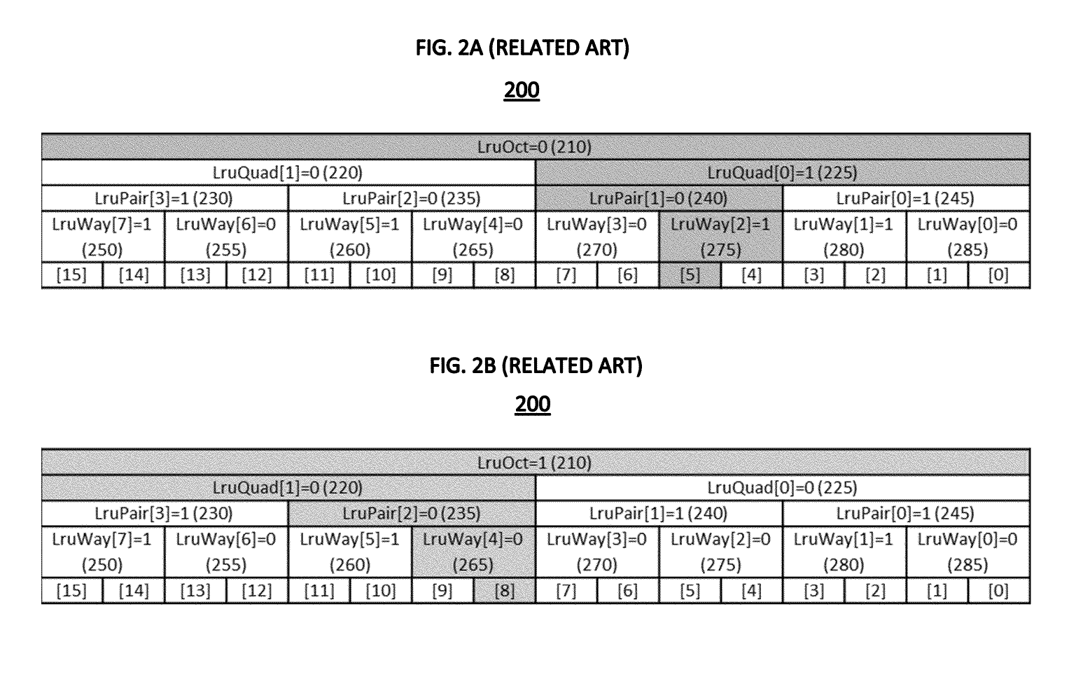

FIGS. 2A and 2B illustrate a pseudo-LRU replacement mechanism.

The cache illustrated in FIGS. 2A and 2B is similar to the cache (100) discussed with respect to FIG. 1, and therefore a detailed description thereof is omitted.

FIG. 2A illustrates the cache (200) prior to allocation of an entry in the cache. As illustrated in FIG. 2A, the least recently used entry is entry 5, which is indicated by the LruOct bit (210), the LruQuad bit (225), the LruPair bit (240), and the LruWay bit (275).

When a valid way is replaced, or when certain way updates (e.g., cache hit), the LRU is updated by adjusting the appropriate LRU bits up the tree to point to the opposite way, pair, quad, and oct bits. This ensures that a different way is selected for the next replacement and that if successive allocations occur all 16 ways will ultimately be chosen in turn.

Accordingly, FIG. 2B illustrates the cache (200) after to allocation of the entry in the cache. As illustrated in FIG. 2B, the bits previously set in FIG. 2A for indicating entry 5 as the LRU are inverted, and the least recently used entry is now entry 8, which is indicated by the LruOct bit (210), the LruQuad bit (220), the LruPair bit (265), and the LruWay bit (265).

The pseudo-LRU scheme described above may be modified, when the cache is partitioned, by adjusting the distance up the LRU tree to make LRU bit modifications (i.e., inversions), and select a replacement way based on the partitioning boundaries of the cache.

For the purposes of this description, the cache is assumed to be 16-way and may be partitioned into four quadrants of 4 ways each. The scheme may readily be extended to eight 2-way partitions, or even sixteen 1-way partitions.

It is assumed that the incoming request for cache access is decoded based on the requestor source (e.g., CPU, GPU, networking, etc.), address, request type, or any other suitable mechanism to determine into which cache quadrant or quadrants the requestor is allowed to allocate.

The cache architecture in the present disclosure may be partitioned among a number of different traffic sources (i.e., requestors). Accordingly, cache architecture embodiments of the present disclosure extend traditional cache replacement methods to suitably support cache partitioning.

As a result, the cache replacement mechanisms of the present disclosure are flexible in terms of the partitioning granularity/options supported, and are area efficient in terms of the number of bits required, while providing good prediction characteristics for replacement ways across each partition.

In the schemes described herein, requests access all partitions of the cache during the cache lookup to determine a cache hit or miss because cache lines allocated by one requestor in one partition may be hit on (i.e., address match) by requests from another requestor belonging to a different partition. However, requests that cause cache allocations may be limited to a subset of cache partitions, thereby allowing partitions to be configured such that allocations from one requestor or requestor group do not displace lines allocated by a different requestor or requestor group.

Each new allocation to the cache accesses the cache with an accompanying ReqAlloc[3:0] signal, which indicates the partition or partitions of the cache into which the new request is allowed to allocate. If no bits are set then no allocation occurs. Accordingly, for example, a CPU may be permitted to access the entire cache. As such, all the bits of the ReqAlloc[3:0] allocation signal may be set. Alternatively, for requestors having only limited access to the cache, fewer than all of the bits of the ReqAlloc[3:0] signal may be set.

According to an embodiment, the ReqAlloc bits are defined as follows for a 16-way cache: bit 0 enables allocation into ways 0 to 3, bit 1 enables allocation into ways 4 to 7, bit 2 enables allocation into ways 8 to 11, and bit 3 enables allocation into ways 12 to 15.

As noted above, a request setting all the ReqAlloc[3:0] bits allows a request to allocate into any entry of the entire cache.

Setting a subset of the ReqAlloc[0:3] allocation bits restricts allocation, and may be used either to partition the cache into different regions for different requestors or to restrict the amount of the cache to which certain specified requestors can allocate, thereby limiting cache pollution. In the event that the ReqAlloc[3:0] allocation signal is used for partitioning the cache, then a separate ReqAllocWay[1:0] allocation signal may optionally be also used to further restrict allocations within a partition, to limit cache pollution.

The scheme supports a flexible set of cache partition options, as discussed below.

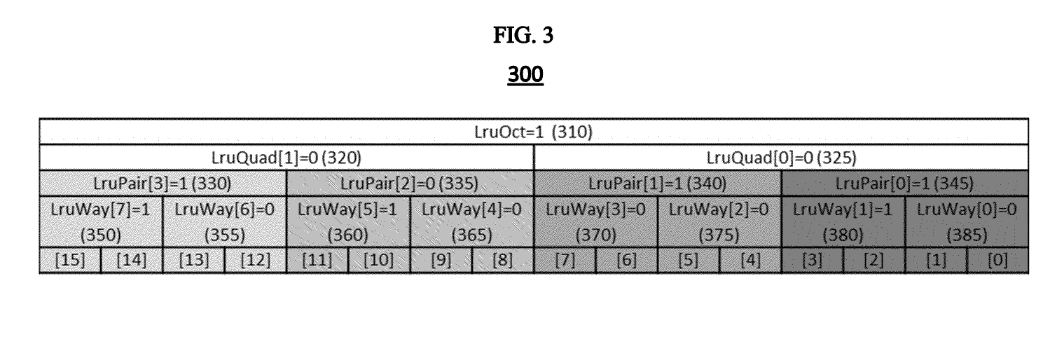

FIG. 3 illustrates a partitioned cache applying a pseudo-LRU replacement policy, according to an embodiment.

The cache (300) illustrated in FIG. 3 is similar to the cache (100) discussed with respect to FIG. 1. Unlike the cache (100) of FIG. 1, however, the cache (300) of FIG. 3 is partitioned into four equal partitions.

As illustrated by the shading in FIG. 3, the first partition includes cache entries 12 to 15, which may be indicated by LruPair[3] bit (330), LruWay[7] (350) bit, and LruWay[6] bit (355), the second partition includes cache entries 8 to 11, which may be indicated by LruPair[2] bit (335), LruWay[5] bit (360), and LruWay[4] bit (365), the third partition includes cache entries 4 to 7, which may be indicated by LruPair[1] bit (340), LruWay[3] bit (370), and LruWay[2] bit (375), and the fourth partition includes cache entries 0 to 3, which may be indicated by LruPair[0] bit (345), LruWay[1] bit (380), and LruWay[0] bit (385). The remaining bits LruOct (310) and LruQuad[0:1] are unnecessary for distinguishing the partitions.

Cache allocation requests to the cache partitions may be indicated by the ReqAlloc[3:0] allocation signal. For example, an allocation request setting ReqAlloc[3:0] to ‘0001’ may be a request to access cache entries 0 to 3 and update only an LRU entry from among the entries 0 to 3 in the requested partition by updating the bits (345, 380, 385) within the partition. Similarly, an allocation request setting ReqAlloc[3:0] to ‘0010’ may be a request to access cache entries 4 to 7 and update only an LRU entry from among the entries 4 to 7 in the requested partition by updating the bits (340, 370, 375) within the partition, an allocation request setting ReqAlloc[3:0] to ‘0100’ may be a request to access cache entries 8 to 11 and update only an LRU entry from among the entries 8 to 11 in the requested partition by updating the bits (335, 360, 365) within the partition, and an allocation request setting ReqAlloc[3:0] to ‘1000’ may be a request to access cache entries 12 to 15 and update only an LRU entry from among the entries 12 to 15 in the requested partition by updating the bits (330, 350, 355) within the partition.

As discussed above, the LRU bits may be updated according to pseudo-LRU by inverting the bits. However, according to the embodiment, as opposed to inverting every bit, only those bits within the partition being updated are inverted.

The ReqAlloc[3:0] allocation signal may also indicate more than one partition. For example, an allocation request setting ReqAlloc [3:0] to ‘1111’ may be a request to access all the cache entries 0 to 15, and perform an LRU update from among all the entries 0 to 15, and an allocation request setting ReqAlloc[3:0] to ‘0101’ may be a request to access the cache entries 0 to 3 and 8 to 11, and perform an LRU update from among all the entries 0 to 3 and 8 to 11.

The correspondence between the ReqAlloc[3:0] allocation signal and the partitions of the cache is merely exemplary, and the skilled artisan will understand that alternative associations may be implemented.

In addition to the correspondence between the ReqAlloc[3:0] allocation signal and the partitions of the cache, a correspondence is established for each requestor. The association of the requestor to the cache partitions may be stored in a configuration file or configuration register. Thereby, requestors may be assigned cache partitions and may read the configuration file or configuration register to request allocation to the particularly assigned cache partition.

As illustrated in FIG. 3, the partitions may be disjoint. For example, four partitions could each allocate into a different quadrant. Alternatively, the partitions could be of different sizes. For example three disjoint partitions could be configured with one partition encompassing two quadrants of the cache and the other two partitions each encompassing one quadrant of the cache.

Additionally, partitions may overlap. For example, a CPU could allocate into all four partitions, whereas a GPU could allocate into two partitions among the partitions allocated to the CPU and networking and video encoding devices could each allocate into one partition among the partitions allocated to the CPU, but being disjoint from the other input/output (I/O) devices.

Moreover, partitions may be equally sized. According to the embodiment of FIG. 3, the cache is partitioned into quadrants. However, the cache may be partitioned into two equal halves, eight equal partitions, or sixteen individual ways. Alternatively, as will be discussed below, the cache may be partitioned into unequal partitions.

Regardless of partitioning of the cache, a requestor may be assigned to a particular partition. However, a requestor may also be limited to only a portion of a partition.

Using a subset of ReqAlloc[3:0] restricts the pseudo-LRU scheme. Only the LRU bits for the selected cache way quadrant or quadrants are used for replacement of a valid line. Accordingly, on a cache replacement, only the portion of the LRU tree corresponding to the selected quadrant or quadrants is updated. This allows the pseudo-LRU scheme to be used with no additional cache array bits required to account for partitioning. The LRU replacement updates and checking of the LRU bits are limited based on the partition quadrants to which the requestor has access. The ReqAlloc allocation bits act as a mask to determine which LRU bits in the LRU tree are either checked or updated based on the partitions into which the requestor is enabled to allocate. Therefore, the LRU way select, pair select, quad select, and oct select are updated and checked only for the quadrants for which the corresponding one or more ReqAlloc[3:0] bits are set.

As opposed to replacement of valid ways, all invalid ways are available for allocation so as long as any ReqAlloc[3:0] allocation bit is set. The replacement of invalid ways for allocation is unrestricted to the selected quadrant.

The use of a ReqAllocWay[1:0] allocation bit also restricts allocations of the LRU scheme. If restricted to a single way, then no update of the LRU tree is performed. This results in the newly allocated line remaining LRU, and hence being next in line to be replaced. If restricted to two ways, the corresponding LruWay bit is updated, but no other LRU bits are modified up the LRU tree.

As with the ReqAlloc[3:0] allocation bits, the use of ReqAllocWay[1:0] allocation bit has no effect on the replacement of invalid ways.

The above description relates to a 16-way cache partitioned in quadrants. However, the partitioning may be extended to cover cache designs with different associativities and/or different partitioning granularity.

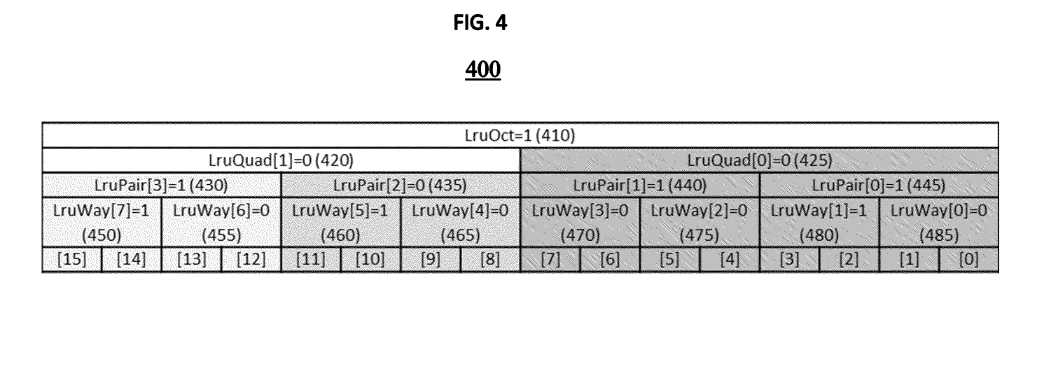

FIG. 4 illustrates a partitioned cache for pseudo-LRU replacement mechanism, according to an embodiment.

As discussed above, the cache partitions may be different sizes. As illustrated in FIG. 4, the cache is partitioned to include three disjoint partitions.

A first partition encompasses two quadrants of the cache and the other two partitions each encompass one quadrant of the cache. Specifically, as illustrated by the shading in FIG. 4, the first partition includes cache entries 12 to 15, which may be indicated by LruPair[3] bit (430), LruWay[7] bit (450), and LruWay[6] bit (455), the second partition includes cache entries 8 to 11, which may be indicated by LruPair[2] bit (435), LruWay[5] bit (460), and LruWay[4] bit (465), and the third partition includes cache entries 0 to 7, which may be indicated by LruQuad[0] bit (425), LruPair[1:2] bits (440, 445), and LruWay[3:0] bits (470-485). The remaining bits LruOct (410) and LruQuad (420) are unnecessary for distinguishing the partitions.

Cache allocation requests to the cache partitions may be indicated by the ReqAlloc[3:0] allocation signal. For example, an allocation request setting ReqAlloc[3:0] to ‘0011’ may be a request to access cache entries 0 to 7 and update only an LRU entry from among the entries 0 to 7 in the requested partition by updating the bits (425, 440, 445, 470-485) within the partition. Similarly, an allocation request setting ReqAlloc[3:0] to ‘0100’ may be a request to access cache entries 8 to 11 and update only an LRU entry from among the entries 8 to 11 in the requested partition by updating the bits (435, 460, 465) within the partition, and an allocation request setting ReqAlloc[3:0] to ‘1000’ may be a request to access cache entries 12 to 15 and update only an LRU entry from among the entries 12 to 15 in the requested partition by updating the bits (430, 450, 455) within the partition.

As discussed above, the LRU bits may be updated according to pseudo-LRU by inverting the bits. However, according to the embodiment, only those bits within the partition being updated are inverted.

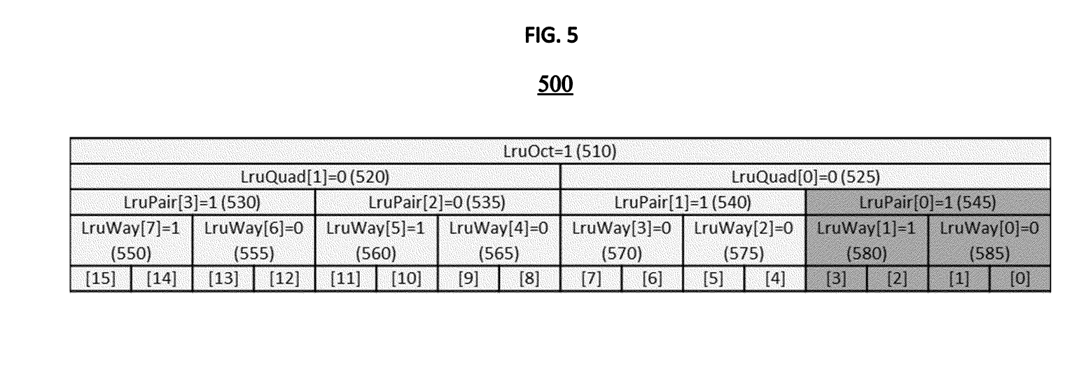

FIG. 5 illustrates a partitioned cache for pseudo-LRU replacement mechanism, according to an embodiment.

As discussed above, the cache partitions may overlap. As illustrated in FIG. 5, the cache is partitioned to include two overlapping partitions.

A first partition encompasses all quadrants of the cache and the other partition encompasses only one quadrant of the cache. Specifically, as illustrated by the shading in FIG. 4, the first partition includes cache entries 0 to 15, which may be indicated by LruOct bit (510), LruQuad[0:1] bits (520, 525), LruPair[0:3] bits (530-545), and LruWay[0:7] bits (550-585) and the second partition may include cache entries 0 to 3, which may be indicated by LruWay [0:3] bits (570-585).

Cache allocation requests to the cache partitions may be indicated by the ReqAlloc[3:0] allocation signal. For example, an allocation request setting ReqAlloc[3:0] to ‘1111’ may be a request to access cache entries 0 to 15 and update an LRU entry from among the entries 0 to 15 in the requested partition by updating the bits, namely all the bits, in the partition, namely the entire cache. Similarly, an allocation request setting ReqAlloc[3:0] to ‘0001’ may be a request to access cache entries 0 to 3 and update only an LRU entry from among the entries 0 to 3 in the requested partition by updating the bits (545, 580, 585) within the partition.

As discussed above, the LRU bits may be updated according to pseudo-LRU by inverting the bits. However, according to the embodiment, only those bits within the partition being updated are inverted.

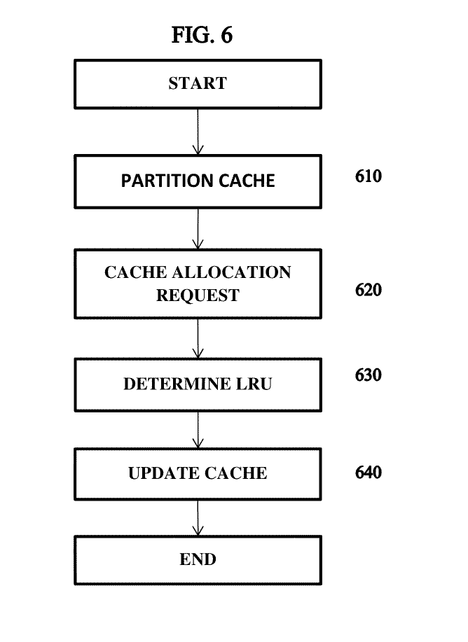

FIG. 6 illustrates a method of managing a partitioned cache according to a pseudo-LRU replacement policy.

As illustrated in FIG. 6, at step 610, a cache is partitioned. As discussed above with respect to FIGS. 3-5, the cache may be partitioned in various ways.

The partitioning may be performed through configuration of a bit mask stored in a register or configuration file. The bit mask may indicate a partition, among partitions of the cache, into which a requestor may allocate an entry into the cache. The register may be associated with the requestor, or requestors may access a shared configuration file, and may read the register or configuration file to determine the bit mask for allocation of the cache request.

In step 620, the requestor may initiate an allocation into the cache. As discussed above, the requestor may employ the ReqAlloc allocation bits to allocate an entry into the cache. A memory controller or the like for controlling the cache, and including a processing module (e.g., CPU, microprocessor, etc.) for controlling operations thereof, may receive the request from the requestor, and search for an entry that is marked as the LRU entry, based on the request, in step 630. For example, if the request indicates a particular partition, the memory manager may search for an LRU entry within the partition, as indicated by the allocation bits in the request.

In step 630, if it is determined that the LRU exists within one partition of the cache, which is not accessible to the requestor, then a next LRU entry may be determined from among the entries within the partition of the cache accessible to the requestor. As discussed above, this is because the requestor is limited to only the allocated partition or partitions of the cache. However, another requestor, such as a CPU, may also have access to the partition and may set the LRU to an entry in another partition.

In step 640, the cache may be updated to reflect the new LRU. As discussed above, the entry may be updated according to a pseudo-LRU policy, in which the LRU bits are inverted. However, only those bits within the partition assigned to the requestor may be inverted. Accordingly, a requestor limited to a particular partition is unable to dominate the cache entries of other requestors having access to other partitions of the cache.

The functions of the embodiments may be embodied as computer-readable codes in a computer-readable recording medium. The computer-readable recording medium includes all types of recording media in which computer-readable data are stored. Examples of the computer-readable recording medium include a ROM, a RAM, a CD-ROM, a magnetic tape, a floppy disk, and an optical data storage. Further, the recording medium may be implemented in the form of carrier waves such as those used in Internet transmission. In addition, the computer-readable recording medium may be distributed to computer systems over a network, in which computer-readable codes may be stored and executed in a distributed manner.

As will also be understood by the skilled artisan, the embodiments may be implemented by any combination of software and/or hardware components, such as a Field Programmable Gate Array (FPGA) or Application Specific Integrated Circuit (ASIC), which performs certain tasks. A unit or module may advantageously be configured to reside on the addressable storage medium and configured to execute on one or more processors or microprocessors. Thus, a unit or module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and units may be combined into fewer components and units or modules or further separated into additional components and units or modules.

A number of embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of performing cache replacement in a cache partitioned into a plurality of partitions, the method comprising:
receiving a request from a requestor to allocate a cache entry into a partition among the plurality of partitions;
determining a least recently used (LRU) cache entry among cache entries in the partition;
allocating the cache entry in the partition; and
setting a next LRU cache entry within the partition.

2. The method of claim 1, wherein the setting comprises:
inverting LRU bits of the cache within the partition.

3. The method of claim 2, wherein the partition is set by a bit mask that indicates the partition among the plurality of partitions.

4. The method of claim 3, wherein the partition comprises at least two partitions among the plurality of partitions, and
wherein the bit mask indicates the at least two partitions.

5. The method of claim 3, wherein the partition comprises a first partition among the plurality of partitions and the plurality of partitions comprises a second partition, and
wherein the first partition is disjoint from the second partition.

6. The method of claim 3, wherein the partition comprises a first partition among the plurality of partitions and the plurality of partitions comprises a second partition, and
wherein cache entries within the first partition are included within cache entries of the second partition.

7. The method of claim 3, wherein the partition comprises a first partition among the plurality of partitions and the plurality of partitions comprises a second partition, and
wherein a size of the first partition is different from a size of the second partition.

8. The method of claim 3, wherein the partition comprises a first partition among the plurality of partitions and the plurality of partitions comprises a second partition, and
wherein a size of the first partition is equal to a size of the second partition.

9. The method of claim 3, wherein the partition comprises a first partition among the plurality of partitions and the plurality of partitions comprises a second partition, and
wherein the first partition and the second partition are quadrant partitions of the cache.

10. The method of claim 3, wherein the partition comprises a first partition among the plurality of partitions and the plurality of partitions comprises a second partition, and
wherein the first partition and the second partition are half partitions of the cache.

11. A memory controller configured to perform cache replacement in a cache partitioned into a plurality of partitions, the memory controller comprising:
a processing module configured to receive a request from a requestor to allocate a cache entry into a partition among the plurality of partitions, determine a least recently used (LRU) cache entry among cache entries in the partition, allocate the cache entry in the partition, and set a next LRU cache entry within the partition.

12. The memory controller of claim 11, wherein the processing module is further configured to set the next LRU by inverting LRU bits of the cache within the partition.

13. The memory controller of claim 12, wherein the partition is set by a bit mask that indicates the partition among the plurality of partitions.

14. The memory controller of claim 13, wherein the partition comprises at least two partitions among the plurality of partitions, and
wherein the bit mask indicates the at least two partitions.

15. The memory controller of claim 13, wherein the partition comprises a first partition among the plurality of partitions and the plurality of partitions comprises a second partition, and
wherein the first partition is disjoint from the second partition.

16. The memory controller of claim 13, wherein the partition comprises a first partition among the plurality of partitions and the plurality of partitions comprises a second partition, and
wherein cache entries within the first partition are included within cache entries of the second partition.

17. The memory controller of claim 13, wherein the partition comprises a first partition among the plurality of partitions and the plurality of partitions comprises a second partition, and
wherein a size of the first partition is different from a size of the second partition.

18. The memory controller of claim 13, wherein the partition comprises a first partition among the plurality of partitions and the plurality of partitions comprises a second partition, and
wherein a size of the first partition is equal to a size of the second partition.

19. The memory controller of claim 13, wherein the partition comprises a first partition among the plurality of partitions and the plurality of partitions comprises a second partition, and
wherein the first partition and the second partition are quadrant partitions of the cache.

20. The memory controller of claim 13, wherein the partition comprises a first partition among the plurality of partitions and the plurality of partitions comprises a second partition, and
wherein the first partition and the second partition are half partitions of the cache.
